(19) United States
(12) Patent Application Publication
(10) Pub. No.: US 2025/0149226 A1
(43) Pub. Date: May 8, 2025

(54) INTEGRATED TRANSFORMER AND COMMON MODE CHOKE WITH TWISTED WINDING TO INCREASE BANDWIDTH

(71) Applicant: Cisco Technology, Inc., San Jose, CA (US)

(72) Inventors: Jianquan Lou, Shanghai (CN); Alpesh U. Bhobe, Sunnyvale, CA (US)

(21) Appl. No.: 18/387,888

(22) Filed: Nov. 8, 2023

(51) Int. Cl. H01F 17/06; H01F 17/00; H01F 27/28

(52) U.S. Cl. CPC H01F 17/062; H01F 27/2823; H01F 27/2895; H01F 2017/0093

(57) ABSTRACT

In one embodiment, an electronic device includes a generally toroidal magnetic core having a first extension portion coupled to a first location of the generally toroidal magnetic core and a second extension portion coupled to a second location of the generally toroidal magnetic core generally opposite the first location and a common mode choke comprising a first wire and a second wire wound around the first extension portion and the second extension portion in a same winding direction. The first wire winds around the generally toroidal magnetic core in a first direction, and the second wire winds around the generally toroidal magnetic core in a second direction to form a primary winding. The electronic device further includes a transformer comprising the primary winding and a secondary winding, wherein the secondary winding of the transformer comprises a third wire and a fourth wire wound around the generally toroidal magnetic core in opposite directions.

### TECHNICAL FIELD

The present disclosure generally relates to communication systems, and more particularly, to electrical components such as connectors and supporting hardware and, even more particularly, to an integrated transformer and common mode choke with twisted winding to increase bandwidth.

### BACKGROUND

Common mode chokes and transformers are frequently used together in various circuits, particularly in power converter circuits and integrated connector modules. Common mode chokes are used to suppress common mode noise and interference in a circuit, while transformers, on the other hand, are used to step up/down voltage levels or provide isolation in a circuit. When used together, common mode chokes and transformers can provide enhanced noise suppression and isolation in a circuit.

In particular, integrated connector modules, which are used in a variety of applications such as Ethernet, often require a high degree of noise suppression and isolation to ensure reliable operation. The use of common mode chokes and transformers in these circuits can help to achieve these goals. However, some integrated transformer and common mode choke components may not be sufficient for use with high-speed ethernet, such as 10G or even 1G ethernet.

### BRIEF DESCRIPTION OF THE DRAWINGS

The implementations herein may be better understood by referring to the following description in conjunction with the accompanying drawings in which like reference numerals may indicate identically or functionally similar elements, of which:

FIG. 1 illustrates an example four-wire twisted winding in accordance with one or more embodiments of the disclosure;

FIG. 2A illustrates an example electronic device in accordance with one or more embodiments of the disclosure;

FIG. 2B illustrates the example electronic device subjected to a differential signal input in accordance with one or more embodiments of the disclosure;

FIG. 2C illustrates the example electronic device subjected to a common mode signal input in accordance with one or more embodiments of the disclosure;

FIGS. 3A-3C illustrate example schematic circuit diagrams of the electronic device of FIGS. 2A-2C, respectively;

FIG. 4A illustrates an example plot showing frequency vs. insertion loss for an electronic device with twisted winding as compared to an electronic device with single winding;

FIG. 4B illustrates another example plot showing frequency vs. common mode noise rejection for another electronic device with twisted winding as compared to an electronic device with single winding;

FIG. 5A illustrates an example plot showing frequency vs. common mode noise rejection for an electronic device with an integrated transformer and common mode choke as compared to an electronic device with a discrete transformer and common mode choke;

FIG. 5B illustrates another example plot showing frequency vs. insertion loss for another electronic device with an integrated transformer and common mode choke as compared to an electronic device with a discrete transformer and common mode choke;

FIG. 6 illustrates an example cross section of an electronic device in accordance with one or more embodiments of the disclosure;

FIG. 7 illustrates an example of an arrangement of a plurality of electronic devices within a communication device in accordance with one or more embodiments of the disclosure;

FIGS. 8A-8B illustrate examples of electronic devices with extension portions extending away from a plane of the electronic devices in accordance with one or more embodiments of the disclosure;

FIG. 9 illustrates an example of an electronic device with extension portions extending away from a center of the electronic device in accordance with one or more embodiments of the disclosure;

FIG. 10 illustrates an example cross section of an electronic device in an alternative embodiment in accordance with one or more embodiments of the disclosure; and

FIG. 11 illustrates an example simplified procedure for an integrated transformer and common mode choke with twisted winding to increase bandwidth.

### DESCRIPTION OF EXAMPLE EMBODIMENTS

### Overview

According to one or more embodiments of the disclosure, an electronic device includes a generally toroidal magnetic core having a first extension portion coupled to a first location of the generally toroidal magnetic core and a second extension portion coupled to a second location of the generally toroidal magnetic core generally opposite the first location and a common mode choke comprising a first wire and a second wire wound around the first extension portion and the second extension portion in a same winding direction. The first wire winds around the generally toroidal magnetic core in a first direction, and the second wire winds around the generally toroidal magnetic core in a second direction to form a primary winding. The electronic device further includes a transformer comprising the primary winding and a secondary winding, wherein the secondary winding of the transformer comprises a third wire and a fourth wire wound around the generally toroidal magnetic core in opposite directions.

Other embodiments are described below, and this overview is not meant to limit the scope of the present disclosure.

### DESCRIPTION

As noted above, common mode chokes and transformers are frequently used together in various circuits, particularly in power converter circuits and integrated connector modules. Two discrete components (common mode choke and transformer) are generally used in most current approaches. However, in order to reduce the volume and weight of the components, it may be necessary to modify the parameters and structure of the magnetic cores used in such common mode chokes and transformers, or to apply different winding methods for each component. These approaches can therefore require complex manufacturing methods that can use more material and/or resources than may be necessary.

For example, electronic device manufacturers often compete to provide smaller electronic devices that maintain (or even increase) performance characteristics. However, the physical dimensions of underlying electronic circuit components may prove a limiting factor when reducing the overall footprint of an electronic device. Accordingly, the techniques described herein combine or integrate certain electronic hardware or circuitry in a smaller single integrated component or module. Specifically, the techniques herein provide an integrated transformer and common mode choke component, which may be used in various types of electronic devices (e.g., connectors, power converters (e.g., DC-DC converters), power supplies, power over Ethernet (PoE) devices, etc.). Such integrated component occupies smaller physical space over separate conventional component configurations and also requires less material to manufacture.

However, as also noted above, some integrated transformer and common mode choke components may not be sufficient for use with high-speed ethernet, such as 10G or even 1G ethernet. Furthermore, simple winding designs of some integrated transformer and common mode choke components may lack a center termination, which could potentially induce resonance or reflection, characteristics that may be undesirable in particular applications. Accordingly, the integrated transformer and common-mode choke component described herein may achieve similar and/or improved signal integrity, noise reduction, and EMI suppression over separate conventional component configurations and/or over some integrated transformer and common mode choke components by providing increased bandwidth and/or reduced resonance or reflection.

The techniques herein provide for a single electrical component (e.g., an “electronic device”) that combines a common mode choke and transformer with a unique twisted winding design that includes an extended (e.g., center) termination. The inclusion of the extended termination can reduce the potential for resonance and/or reflection, while the unique twisted winding design can provide increased bandwidth for the electrical component. In some embodiments, the increased bandwidth can allow for the electrical component to be deployed in applications that utilize bandwidth frequencies of ten gigahertz (GHz), i.e., 10G, or higher. These and other aspects of the disclosure can allow for the electrical component to be suitable for use with high-speed communications, such as high-speed ethernet (e.g., Gigabit ethernet, etc.). As described in more detail, aspects described herein can improve the performance of the electrical component while maintaining a compact size and weight.

Specifically, according to one or more embodiments of the disclosure as described in detail below, an electronic device includes a generally toroidal magnetic core having a first extension portion coupled to a first location of the generally toroidal magnetic core and a second extension portion coupled to a second location of the generally toroidal magnetic core generally opposite the first location and a common mode choke comprising a first wire and a second wire wound around the first extension portion and the second extension portion in a same winding direction. The first wire winds around the generally toroidal magnetic core in a first direction, and the second wire winds around the generally toroidal magnetic core in a second direction to form a primary winding. The electronic device further includes a transformer comprising the primary winding and a secondary winding, wherein the secondary winding of the transformer comprises a third wire and a fourth wire wound around the generally toroidal magnetic core in opposite directions.

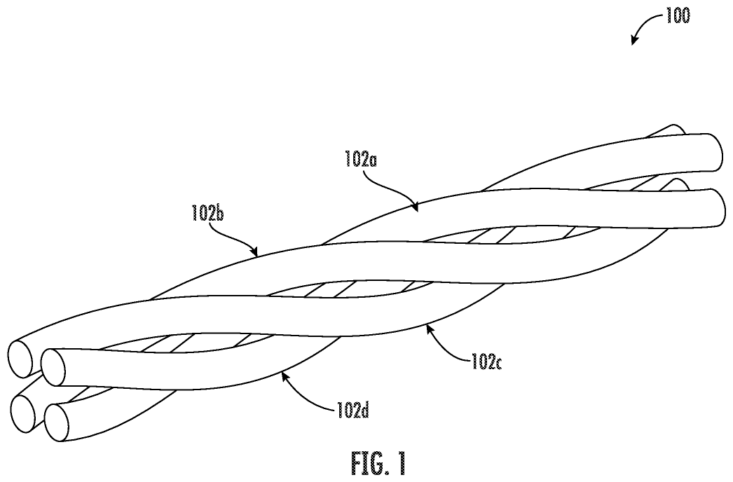

Operationally, FIG. 1 illustrates an example four-wire twisted winding 100 in accordance with one or more embodiments of the disclosure. As shown in FIG. 1, the four-wire twisted winding 100 incudes a first wire 102a, a second wire 102b, a third wire 102c, and a fourth wire 102d. The first wire 102a, the second wire 102b, the third wire 102c, and the fourth wire 102d are twisted about one another to form the four-wire twisted winding 100. The first wire 102a, the second wire 102b, the third wire 102c, and the fourth wire 102d can be formed of any suitable electrically conductive material, such as aluminum, copper, various electrically conductive alloys, etc.

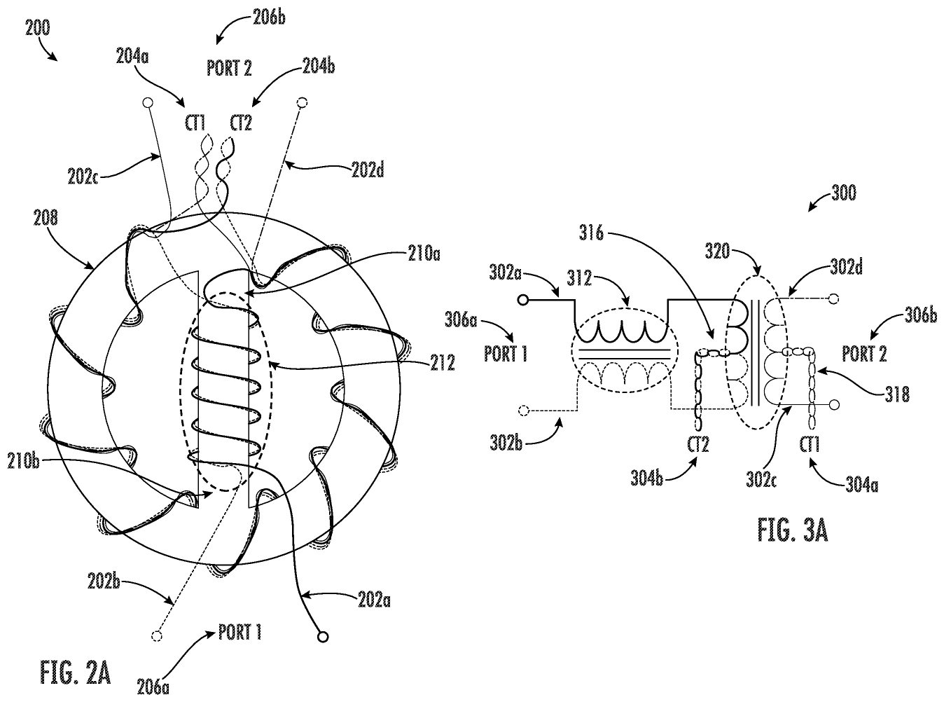

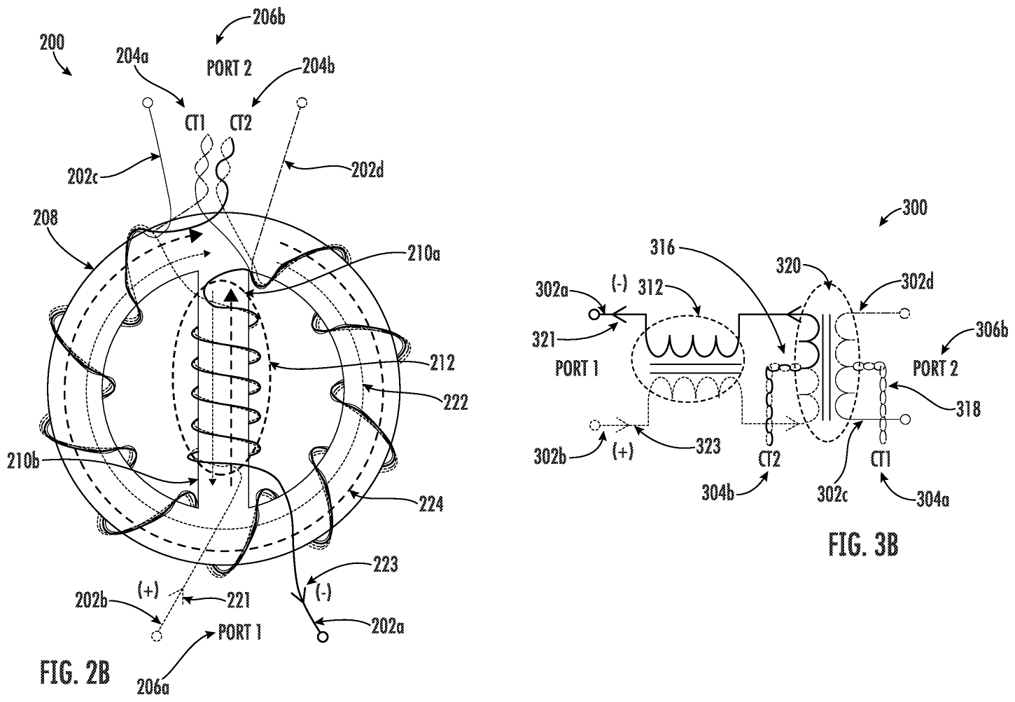

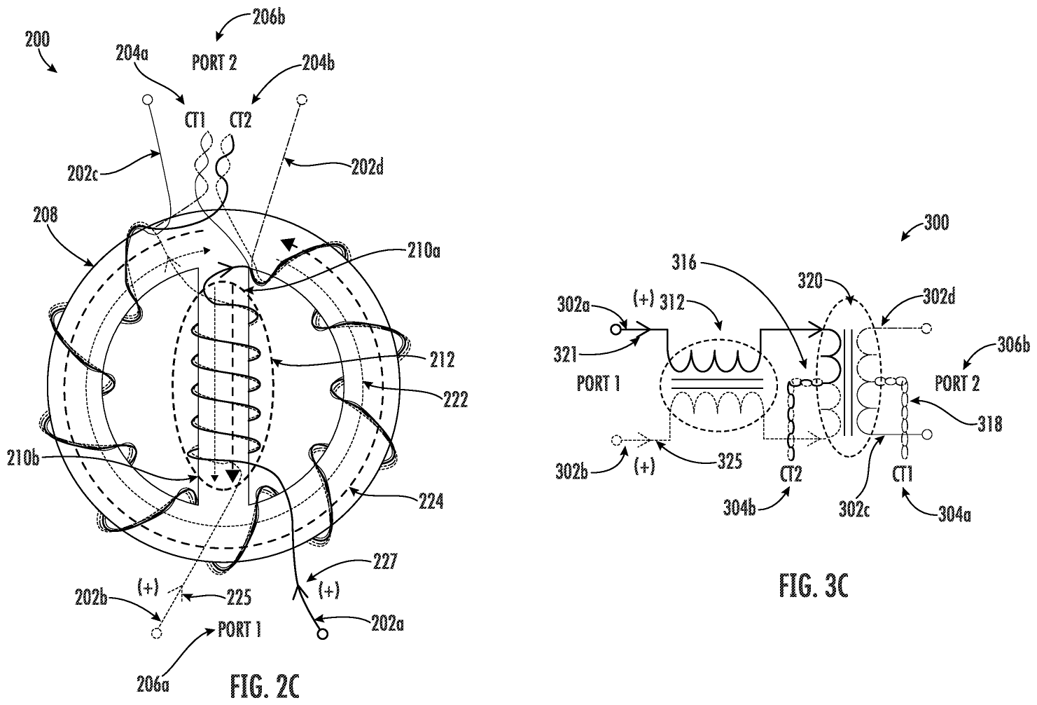

In some embodiments, the four-wire twisted winding 100 can provide an increase in bandwidth to an electrical component (e.g., the electronic device 200 of FIG. 2A) around which the first wire 102a, the second wire 102b, the third wire 102c, and/or the fourth wire 102d are wound, as discussed in more detail below.

FIG. 2A illustrates an example electronic device 200 in accordance with one or more embodiments of the disclosure, namely an integrated transformer and common mode choke with twisted winding herein. As shown in FIG. 2A, the electronic device 200 includes a generally toroidal magnetic core 208 that has a first extension portion 210a (e.g., a center termination) coupled to a first location of the generally toroidal magnetic core 208 and a second extension portion 210b coupled to a second location of the generally toroidal magnetic core 208 that is generally opposite the first location. That is, as shown in FIG. 2A, the first extension portion 210a is coupled to an interior portion of the generally toroidal magnetic core 208 on one side of the generally toroidal magnetic core 208, while the second extension portion 210b is coupled to an interior portion of the generally toroidal magnetic core 208 on a different side of the generally toroidal magnetic core 208.

As used herein, the term “generally,” particularly with respect to the generally toroidal magnetic core 208, refers to a characteristic or set of characteristics whereby the magnetic core is formed in the shape of a torus, but, due to manufacturing constraints and/or process variations may not be formed as an exact torus. However, the generally toroidal magnetic core 208 is formed within manufacturing tolerances such that the effect of an exact torus shaped magnetic core are achieved (or are achieved nearly enough) that the generally toroidal magnetic core 208 functions as a toroidal magnetic core.

In some embodiments, the first extension portion 210a and the second extension portion 210b can be coupled to the interior portions of the generally toroidal magnetic core 208 to form a cross-bar within the generally toroidal magnetic core 208. In such embodiments, the cross-bar can form an elliptical shape (as opposed to a straight shape), a square or rectangular shape (as opposed to an elliptical shape), or other geometric shape.

Further, although the first extension portion 210a and the second extension portion 210b are illustrated as being coupled to interior portions of the generally toroidal magnetic core 208, embodiments are not so limited. For example, in some embodiments, the first extension portion 210a and the second extension portion 210b can be coupled to exterior portions of the generally toroidal magnetic core 208 provided that the twisted wiring configuration(s) described herein is followed with respect to winding the wires around the generally toroidal magnetic core 208, the first extension portion 210a, and the second extension portion 210b.

Continuing on, as shown in FIG. 2A, the electronic device 200 includes a first wire 202a, a second wire 202b, a third wire 202c, and/or a fourth wire 202d, which can be analogous to the first wire 102a, the second wire 102b, the third wire 102c, and/or the fourth wire 102d of FIG. 1. In addition, the electronic device 200 includes two ports—a first port 206a and a second port 206b, as well as a first center tap 204a (“CT1”) and a second center tap 204b (“CT2”).

In some embodiments, the first extension portion 210a and the second extension portion 210b are formed in the shape of a cylinder, although embodiments are not so limited and the first extension portion 210a and the second extension portion 210b are formed in the shape of a quadrilateral, among other shapes. As discussed in more detail below, the first wire 202a, the second wire 202b, the third wire 202c, and/or the fourth wire 202d are wound around at least a portion of the generally toroidal magnetic core 208, the first extension portion 210a, and/or the second extension portion 210b.

For example, as shown in FIG. 2A, two input wires (e.g., the first wire 202a and the second wire 202b), which initiate from the first port 206a, are wound in a same direction around the first extension portion 210a and the second extension portion 210b to form a common mode choke 212. After passing through the common mode choke 212, the first wire 202a and the second wire 202b are separated (e.g., are not twisted together) and one of the first wire 202a and the second wire 202b is wrapped around the generally toroidal magnetic core 208 in a first direction while the other one of the first wire 202a and the second wire 202b is wrapped around the generally toroidal magnetic core 208 in a second direction. That is, as shown in FIG. 2A, after passing through the common mode choke 212, the first wire 202a is wrapped around the generally toroidal magnetic core 208 in a clockwise manner, while the second wire 202b is wrapped around the generally toroidal magnetic core 208 in an anti-clockwise manner, although embodiments are not so limited.

The first wire 202a and the second wire 202b are then merged again at the second center tap 204b (“CT2”) of the electronic device 200 to form a primary winding (e.g., the primary winding 316) for the transformer (e.g., the transformer 320 of FIG. 3A, described below) of the electronic device 200.

Similarly, the third wire 202c and the fourth wire 202d, which initiate from the second port 206b, are also wrapped around the generally toroidal magnetic core 208 in opposite directions. That is, as shown in FIG. 2A, the third wire 202c is wrapped around the generally toroidal magnetic core 208 in an anti-clockwise manner, while the fourth wire 202d is wrapped around the generally toroidal magnetic core 208 in a clockwise manner, although embodiments are not so limited. The third wire 202c and the fourth wire 202d are merged at the first center tap 204a (“CT1”) to form a secondary winding (e.g., the secondary winding 318 of FIG. 3A) for the transformer (e.g., the transformer 320 of FIG. 3A) of the electronic device 200.

It is noted that, while the four wires (e.g., the first wire 202a, the second wire 202b, the third wire 202c, and the fourth wire 202d) are wound around the generally toroidal magnetic core 208, the four wires are twisted together as shown in FIG. 1. As mentioned above, this four-wire twisting configuration may serve to improve the bandwidth of the electronic device 200.

Continuing with this non-limiting example, the electronic device 200 can further include a common mode choke (e.g., the common mode choke 312 of FIG. 3A) comprising a first wire 202a and a second wire 202b wound around the first extension portion 210a and the second extension portion 210b in a same winding direction. Subsequent to the common mode choke, the first wire 202a winds around the generally toroidal magnetic core 208 in a first direction, and the second wire 202b winds around the generally toroidal magnetic core 208 in a second direction to form a primary winding (e.g., the primary winding 316 of FIG. 3A). As mentioned above, the first direction can be a clockwise direction with respect to the generally toroidal magnetic core 208 and the second direction can be an anti-clockwise direction with respect to the generally toroidal magnetic core 208, although embodiments are not so limited.

The electronic device 200 can further include a transformer (e.g., the transformer 320 of FIG. 3A) comprising the primary winding and a secondary winding (e.g., the secondary winding 318 of FIG. 3A), wherein the secondary winding of the transformer comprises a third wire 202c and a fourth wire 202d wound around the generally toroidal magnetic core 208 in opposite directions.

In some embodiments, the first wire 202a, the second wire 202b, the third wire 202c, and the fourth wire 202d can be twisted together when wrapped around the generally toroidal magnetic core 208, as shown in FIG. 1. Further, the first wire 202a, the second wire 202b, the third wire 202c, and the fourth wire 202d can be twisted together when wrapped around the generally toroidal magnetic core 208 to cause the transformer to meet a bandwidth criterion. In some embodiments, the bandwidth criterion can correspond to a 10-GHz bandwidth requirement, although embodiments are not so limited.

In some embodiments, the electronic device 200 can further include a first port 206a and a second port 206b. In such embodiments, the first wire 202a and the second wire 202b can be coupled to the first port 206a, and the third wire 202c and the fourth wire 202d can be coupled to the second port 206b. Further, the first wire 202a and the second wire 202b can be configured as inputs to the first port 206a, while the third wire 202c and the fourth wire 202d can be configured as inputs to the second port 206b. As described in more detail herein, in some embodiments, the first port 206a can be configured to receive a common mode signal to operate the common mode choke.

Continuing with this non-limiting example, the third wire 202c and the fourth wire 202d can be merged at a first center tap 204a to form the secondary winding, while the first wire 202a and the second wire 202b can be merged at a second center tap 204b to form the primary winding.

In some embodiments, the electronic device 200 can be deployed in a computer networking device. For example, the generally toroidal magnetic core 208, the common mode choke, and the transformer can be deployed in a computer networking device. In such embodiments, the electronic device 200 may be coupled to a printed circuit board and deployed as part of a system inside the computer networking device. Non-limiting examples of computer networking devices can include network switches, network routers, etc.

FIG. 3A illustrates an example schematic circuit diagram of the electronic device 200 of FIG. 2A. As shown in FIG. 3A, a first wire 302a, a second wire 302b, a third wire 302c, and a fourth wire 302d, which can be analogous to the first wire 202a, the second wire 202b, the third wire 202c, and the fourth wire 202d of FIG. 2A, are provided as part of an electronic device 300. The electronic device 300 may be analogous to the electronic device 200 of FIG. 2A.

As shown in FIG. 3A, the first wire 302a and the second wire 302b initiate from a first port 306a, which can be analogous to the first port 206a of FIG. 2A. The first wire 302a and the second wire 302b pass through the common mode choke 312 and are twisted together at the second center tap 304b, which can be analogous to the second center tap 204b of FIG. 2A.

The third wire 302c and the fourth wire 302d initiate from a second port 306b, which can be analogous to the second port 206b of FIG. 2A. The third wire 302c and the fourth wire 302d are twisted together at the first center tap 304a, which can be analogous to the first center tap 204a of FIG. 2A.

As mentioned above, the first wire 302a and the second wire 302b form a primary winding 316 of the transformer 320, while the third wire 302c and the fourth wire 302d form a secondary winding 318 of the transformer 320.

FIG. 2B illustrates an example electronic device 200 subjected to a differential signal input in accordance with one or more embodiments of the disclosure. As shown, when a differential signal is fed into the first port 206a, the direction of current flows in a direction as shown by the first current path 221 and the second current path 223 (and the first current path 321 and the second current path 323 of FIG. 3B). In some embodiments, the magnetic flux generated by the first wire 202a and the second wire 202b is represented by the first magnetic flux path 222 and the second magnetic flux path 224. According to Ampere's right-hand spiral rule, the magnetic flux generated by the first wire 202a and the second wire 202b can be nullified at the center of the object formed by the first extension portion 210a and the second extension portion 210b, which, in some embodiments can be a cylinder, quadrilateral, or other shape. This leads to a scenario in which there is zero (or near-zero) attenuation for the differential signal.

However, the magnetic flux may then be combined in the generally toroidal magnetic core 208, thereby creating a magnetic flux that is induced in the primary winding (e.g., the primary winding 316 of FIG. 3B) for the transformer (e.g., the transformer 320 of FIG. 3B). In such embodiments, a corresponding current flow is therefore induced in the third wire 202c and the fourth wire 202d, which, as discussed above form a secondary winding (e.g., the secondary winding 318 of FIG. 3B) of the transformer. In this example, the output signal of the electronic device 200 is ultimately delivered through the second port 206b and corresponds to operation of the electronic device 200 in a mode of operation associated with a transformer.

FIG. 3B illustrates an example schematic circuit diagram of the electronic device of FIG. 2B subjected to a differential signal input in accordance with one or more embodiments of the disclosure. As shown in FIG. 3B, when a differential signal is fed into the first port 306a, the direction of current flows in a direction as shown by the first current path 321 and the second current path 323, analogous to the embodiment of FIG. 2B. This may cause a magnetic flux to be induced in the primary winding 316 for the transformer 320 while a corresponding current flow is induced in the secondary winding 318 of the transformer 320. As discussed above, this causes the output signal of the electronic device 300 to be delivered through the second port 306b and corresponds to operation of the electronic device 200 in a mode of operation associated with a transformer.

FIG. 2C illustrates an example electronic device subjected to a common mode signal input in accordance with one or more embodiments of the disclosure. As shown in FIG. 2C, when a common mode signal is fed into the first port 206a, the direction of current flows in a direction as shown by the first current path 225 and the second current path 227 (and the first current path 325 and the second current path 327 of FIG. 3C). In such embodiments, the resulting magnetic flux is combined at the center of the object formed by the first extension portion 210a and the second extension portion 210b, which, in some embodiments can be a cylinder, quadrilateral, or other shape, leading to attenuation of the common mode signal as a choke.

Further, in such embodiments, the current flow in the electronic device 200 may be terminated at the second center tap 204b (“CT2”). However, the magnetic flux may be nullified in the generally toroidal magnetic core 208, resulting in zero (or near-zero) current induction in the third wire 202c and the fourth wire 202d. Accordingly, in the embodiments shown in FIG. 2C, the electronic device 200 may operate in a mode of operation associated with a common mode choke.

FIG. 3C illustrates an example schematic circuit diagram of the electronic device of FIG. 2C subjected to a common mode signal input in accordance with one or more embodiments of the disclosure. As shown in FIG. 3C, when a common mode signal is fed into the first port 306a, the direction of current flows in a direction as shown by the first current path 325 and the second current path 327, analogous to the embodiment of FIG. 3C. This may cause the magnetic flux to be nullified in the generally toroidal magnetic core 208, resulting in zero (or near-zero) current induction in the third wire 302c and the fourth wire 302d. As discussed above, this causes the electronic device 200 to operate a mode of operation associated with a common mode choke.

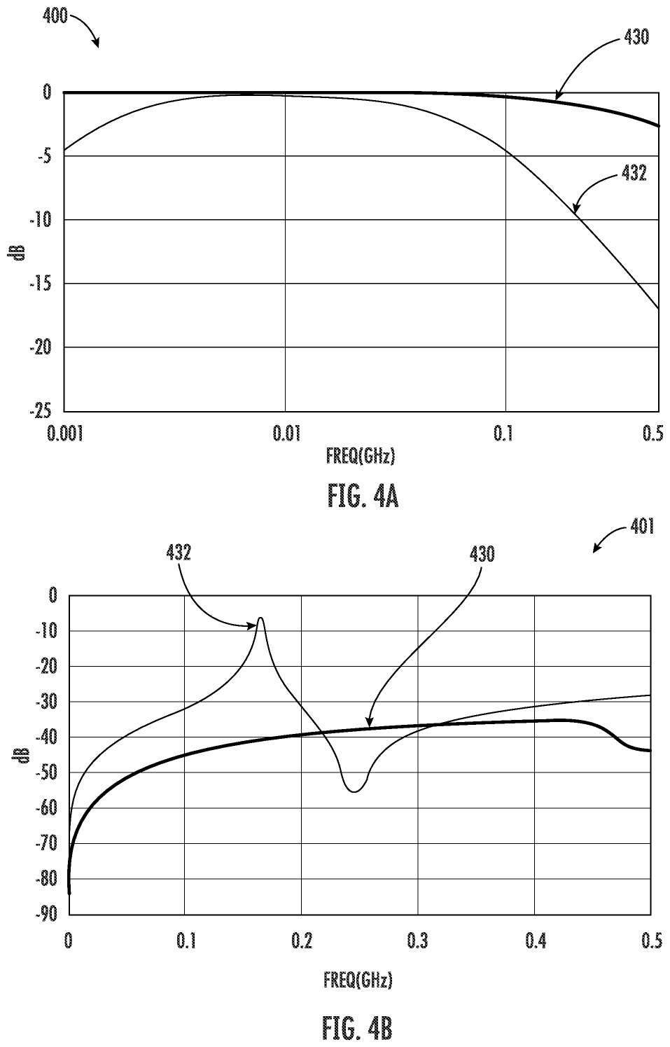

FIG. 4A illustrates an example plot 400 showing frequency vs. insertion loss for an electronic device with twisted winding as compared to an electronic device with single winding. The electronic device can be analogous to the electronic device 200 illustrated herein FIG. 2A.

In FIG. 4A, the frequency is represented along the x-axis in terms of GHz, while the insertion loss is represented along the y-axis in terms of decibels (dB). It will be appreciated that the frequency illustrated in the plot 400 of FIG. 4A can correspond to a bandwidth provided by the electronic device, while the insertion loss can correspond to a measurement of how much useful signal (e.g., how much useful differential signal) passes from the first port to the second port.

In FIG. 4A, the curve 430 represents the behavior of an electronic device (e.g., the electronic device 200 described herein) that is provided with the twisted wiring configuration(s) described herein, while the curve 432 represents the behavior of electronic devices having a single winding.

As illustrated in FIG. 4A, it appears to be evident that the twisted winding, such as the four-wire twisted winding 100 of FIG. 1 can provide a significantly wider bandwidth and/or a significant improvement as compared to electronic devices having a single winding. These and other aspects of the disclosure can therefore utilize bandwidth frequencies of ten GHz or higher for data transmission and other electronic communications.

FIG. 4B illustrates an example plot 401 showing frequency vs. common mode noise rejection for another electronic device with twisted winding as compared to an electronic device with single winding. That is, the electronic device with single winding of FIG. 4A is a different electronic device with single winding than the electronic device with single winding of FIG. 4B. In FIG. 4B, the frequency is represented along the x-axis in terms of GHz, while the common mode noise rejection is represented along the y-axis in terms of decibels (dB). It will be appreciated that the frequency illustrated in the plot 401 of FIG. 4B can correspond to a bandwidth provided by the electronic device, while the noise can correspond to various noise effects that may be present in electronic circuits, such as resonance, reflection, etc. For example, the common mode noise rejection can correspond to an amount of noise that is attenuated or reflected while noise passes from the first port to the second port. The electronic device can be analogous to the electronic device 200 illustrated herein in FIG. 2A, FIG. 2B, and/or FIG. 2C.

In FIG. 4B, the curve 430 represents the behavior of an electronic device (e.g., the electronic device 200 described herein) that is provided with the twisted wiring configuration(s) described herein, while the curve 432 represents the behavior of electronic devices having a single winding.

As illustrated in FIG. 4B, it appears to be evident that the twisted winding, such as the four-wire twisted winding 100 of FIG. 1 can provide a significantly wider bandwidth and/or a significant improvement as compared to electronic devices having a single winding. These and other aspects of the disclosure can therefore utilize bandwidth frequencies of ten GHz or higher for data transmission and other electronic communications.

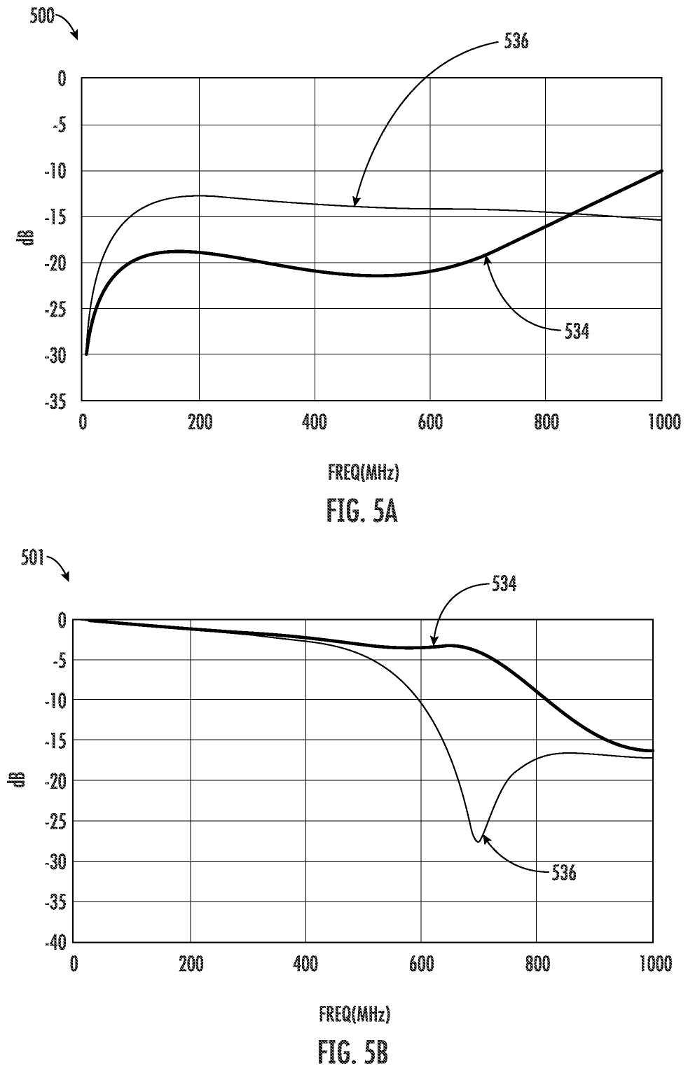

FIG. 5A illustrates an example plot 500 showing frequency vs. common mode noise rejection for an electronic device with an integrated transformer and common mode choke as compared to an electronic device with a discrete transformer and common mode choke. The electronic device can be analogous to the electronic device 200 illustrated herein in FIG. 2A.

In FIG. 5A, the frequency is represented along the x-axis in terms of MHz, while the common mode noise rejection is represented along the y-axis in terms of decibels (dB). It will be appreciated that the frequency illustrated in the plot 500 of FIG. 5A can correspond to a bandwidth provided by the electronic device, while the noise can correspond to a measurement of a signal-to-noise ratio (SNR) and/or any combination of noise(s) that are present in electronic circuits. In at least some embodiments, the noise(s) can be particularly applicable to common mode rejection circuits, where noise(s) such as resonance, reflection, etc. can cause an adverse effect in the efficacy of such circuits. In some embodiments, the common mode noise rejection can correspond to an amount of noise that is attenuated or reflected while noise passes from the first port to the second port.

In FIG. 5A, the curve 534 represents the behavior of an electronic device (e.g., the electronic device 200, described herein) that is provided with the integrated transformer and common mode choke described herein, while the curve 536 represents the behavior of electronic devices having a discrete transformer and common mode choke.

As illustrated in FIG. 5A, it appears evident that the electronic device having the integrated transformer and common mode choke demonstrates better insertion loss and common mode rejection compared to the electronic device having the discrete transformer and common mode choke. It is noted that the integrated design of the present disclosure likely provides better electrical performance due to the closer coupling between the choke and transformer.

FIG. 5B illustrates another example plot 501 showing frequency vs. insertion loss for another electronic device with an integrated transformer and common mode choke as compared to an electronic device with a discrete transformer and common mode choke. That is, the electronic device with integrated transformer and common mode choke of FIG. 5A is a different electronic device with integrated transformer and common mode choke than the electronic device with integrated transformer and common mode choke of FIG. 5B.

In FIG. 5B the frequency is represented along the x-axis in terms of MHz, while the insertion loss is represented along the y-axis in terms of decibels (dB). It will be appreciated that the frequency illustrated in the plot 501 of FIG. 5B can correspond to a bandwidth provided by the electronic device, while the insertion loss can correspond to a measurement of how much useful signal (e.g., how much useful differential signal) passes from the first port to the second port.

In FIG. 5B, the curve 534 represents the behavior of an electronic device (e.g., the electronic device 200, described herein) that is provided with the integrated transformer and common mode choke described herein, while the curve 536 represents the behavior of electronic devices having a discrete transformer and common mode choke.

As illustrated in FIG. 5B, it appears evident that the electronic device having the integrated transformer and common mode choke demonstrates better insertion loss and common mode rejection compared to the electronic device having the discrete transformer and common mode choke. It is noted that the integrated design of the present disclosure likely provides better electrical performance due to the closer coupling between the choke and transformer.

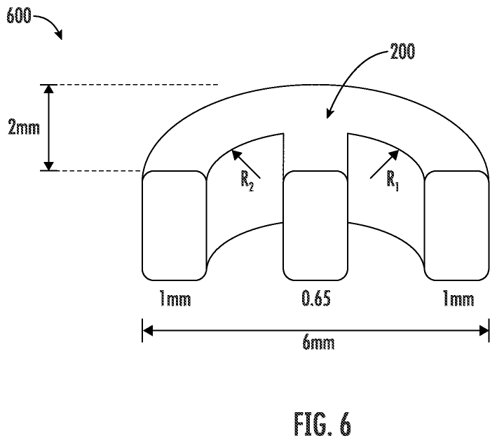

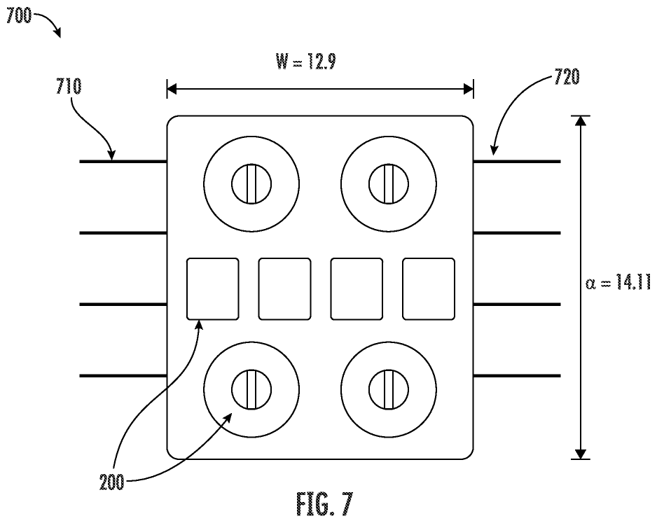

FIG. 6 illustrates an example simplified cross section 600 of an electronic device 200 in accordance with one or more embodiments of the disclosure. Also, FIG. 7 illustrates a simplified example of an arrangement of a plurality of electronic devices (electronic device 200) within a communication device 700 (e.g., with input ports 710 and output ports 720) in accordance with one or more embodiments of the disclosure. For example, communication device 700 may be a component of a printed circuit board deployed in a computer networking device, as will be appreciated by those skilled in the art.

In order to ensure that the electronic device 200 has a size that can be readily deployed in various housings, such as housings that are used to contain electrical interfaces suitable for transmitting electrical signals in a communication network (e.g., communication device 700, measuring approximately 12.9 mm wide by 14.1 mm long), the electronic device 200 can be manufactured to meet certain size restrictions. In one non-limiting example, the generally toroidal magnetic core 208 can have an interior diameter of around 2.0 millimeters (mm) and an outer diameter of around 4.0 mm. In this non-limiting example, the width of the generally toroidal magnetic core 208 is therefore around 1.0 mm.

Embodiments are not so limited, however, and in some embodiments, the generally toroidal magnetic core 208 can have an interior diameter of around 4.0 millimeters (mm) and an outer diameter of around 6.0 mm, or the generally toroidal magnetic core 208 can have an interior diameter of around 1.3 mm, an outer diameter of around 2.6 mm, and a width of around 0.65 mm, or the generally toroidal magnetic core 208 can have an interior diameter of around 2.0 mm, an outer diameter of around 3.55 mm, and a width of around 1.0 mm, among other possible sizes. Further, the generally toroidal magnetic core 208 can be manufactured to have various heights. For example, in some embodiments, the generally toroidal magnetic core 208 can have a height of around 2.55 mm, a height of around 1.25 mm, and so on and so forth.

The first extension portion 210a and the second extension portion 210b can, in some embodiments, have a width that is less than the width of the generally toroidal magnetic core 208. For example, if the width of the generally toroidal magnetic core 208 is around 1.0 mm, the first extension portion 210a and the second extension portion 210b can have a width of around 0.65 mm.

Further, the generally toroidal magnetic core 208, the first extension portion 210a, and the second extension portion 210b can be manufactured in various shapes. For example, in some embodiments, the generally toroidal magnetic core 208, the first extension portion 210a, and the second extension portion 210b can have a generally cylindrical cross-sectional shape. Embodiments are not so limited, however, and in some embodiments, the generally toroidal magnetic core 208, the first extension portion 210a, and the second extension portion 210b can have a generally quadrilateral cross-sectional shape.

In some embodiments, the four wires (e.g., the first wire 202a, the second wire 202b, the third wire 202c, and the fourth wire 202d) can each have a diameter on the order of tens of Angstroms (Å). For example, in some embodiments, the diameter of each of the four wires can be around 38 to 39 Å, although embodiments are not so limited.

It will be appreciated that the foregoing shapes, sizes, and dimensions are merely approximate and are provided in the interest of providing the reader with a rough idea of the shape and size of the electronic device 200 of the disclosure. Accordingly, it will be appreciated that the electronic device 200 may exhibit variances in the shapes, sizes, and dimensions mentioned above due to, for example, manufacturing tolerances, process variations, etc.

As described above, an electronic device 200 can include a generally toroidal magnetic core 208 having a first extension portion 210a coupled to a first location of the generally toroidal magnetic core 208 and a second extension portion 210b coupled to a second location of the generally toroidal magnetic core 208 that is generally opposite the first location. In some embodiments, particularly as illustrated in FIG. 2A above, the first extension portion 210a and the second extension portion 210b extend toward a center region of the generally toroidal magnetic core 208 and meet at a midpoint of the center region to form a center pathway connection for the generally toroidal magnetic core 208.

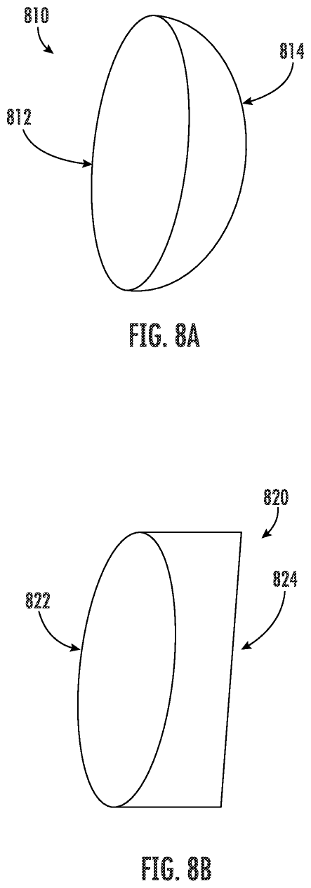

Also, as shown, the first extension portion 210a and the second extension portion 210b can extend co-planarly with respect to the generally toroidal magnetic core 208. Embodiments are not so limited, however, and in some embodiments, the first extension portion 210a and the second extension portion 210b can extend in parallel in a direction away from a plane of the generally toroidal magnetic core 208 and/or the first extension portion 210a and the second extension portion 210b can connect to one another to form a non-planar pathway connection. Examples of this are shown in FIGS. 8A-8B, which illustrate examples of electronic devices 810 and 820 with extension portions 814 (curved) and extension portions 824 (squared) extending away from a plane of the electronic devices (cores 812 and 822, respectively) in accordance with one or more embodiments of the disclosure. (While windings are not specifically shown, those skilled in the art will understand the similarity to electronic device 200 and associated placements of wires 202a-d, accordingly.)

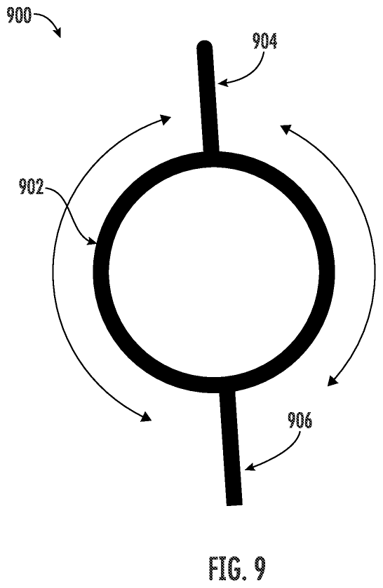

Moreover, according to an alternative embodiment, the first extension portion 210a and the second extension portion 210b may extend away from a center region of the generally toroidal magnetic core 208. That is, FIG. 9 illustrates an example of an electronic device 900 with extension portions 904 and 906 each extending away from a center of the core 902 of the electronic device in accordance with one or more embodiments of the disclosure. (Again, while windings are not specifically shown, those skilled in the art will appreciate the similarity to electronic device 200, where here associated placements of wires 202a-d may extend outwardly wrapped along extension portions 904 and 906 in various suitable configurations, accordingly.)

In any event, the first extension portion 210a and the second extension portion 210b can be cylindrical in shape. Embodiments are not so limited, however, and in some embodiments, the first extension portion 210a and the second extension portion 210b can be quadrilateral in shape. Further, as discussed above, in some embodiments, the first extension portion 210a and the second extension portion 210b can be thinner than the generally toroidal magnetic core 208, or the first extension portion 210a and the second extension portion 210b can be thicker than the generally toroidal magnetic core 208.

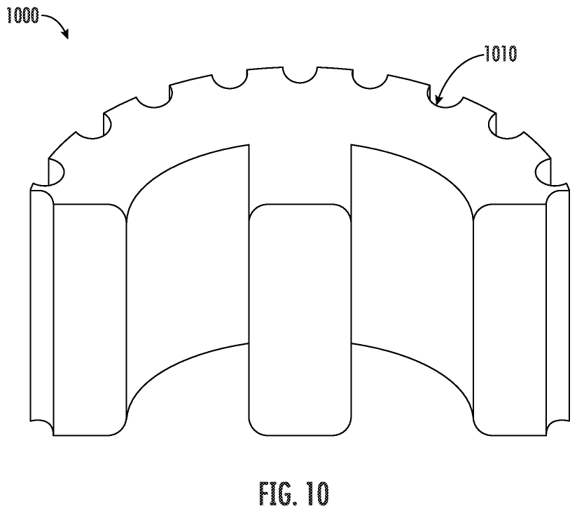

Still further, other features may be considered for the electronic device 200 herein, such as the grooves 1010 shown on illustrative electronic device 1000 (shown in cross section) of FIG. 10. Such grooves, for instance, may allow for reduced thicknesses, and also adds greater predictability in wiring during manufacturing/winding.

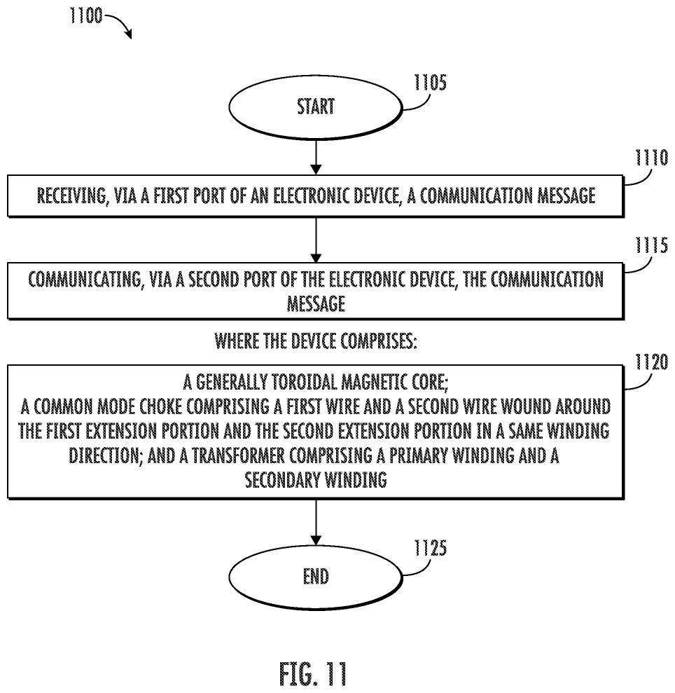

FIG. 11 illustrates an example simplified procedure for an integrated transformer and common mode choke with twisted winding to increase bandwidth, in accordance with one or more implementations described herein. The procedure 1100 may start at step 1105, and continues to step 1110, where, as described in greater detail above, a communication message is received via a first port (e.g., the first port 206a of FIG. 2A) of an electronic device (e.g., the electronic device 200 of FIG. 2A).

At step 1115, the communication message can be communicated via a second port (e.g., the second port 206b of FIG. 2A) of the electronic device.

As shown at step 1120, as detailed above, the electronic device can include a generally toroidal magnetic core having a first extension portion coupled to a first location of the generally toroidal magnetic core and a second extension portion coupled to a second location of the generally toroidal magnetic core generally opposite the first location, a common mode choke comprising a first wire and a second wire wound around the first extension portion and the second extension portion in a same winding direction, and a transformer comprising the primary winding and a secondary winding, wherein the secondary winding of the transformer comprises a third wire and a fourth wire wound around the generally toroidal magnetic core in opposite directions.

In some embodiments, as detailed above, subsequent to the common mode choke, the first wire winds around the generally toroidal magnetic core in a first direction, and the second wire winds around the generally toroidal magnetic core in a second direction to form a primary winding.

Procedure 1100 then ends at step 1125.

It should be noted that while certain steps within procedure 1100 may be optional as described above, the steps shown in FIG. 11 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The devices and techniques described herein, therefore, provide an integrated component that combines a transformer and a common-mode choke using a common core. The integrated component filters out common-mode noise from signals (e.g., common mode choke) while also passes un-attenuated differential signals (electromagnetic induction/transformation). The integrated component further has similar or better signal integrity and electromagnetic interference performance when compared to conventional separate component designs. Further, the integrated components disclosed herein occupy less volume, require less material, and have less mass/weight over conventional separate component designs.

Moreover, aspects of the present disclosure, which feature the twisted winding configurations descried herein and feature center tap termination, offers the ability to meet the requirements for 10GBase-T Ethernet or even higher speed Ethernet in a single component. As discussed above, the electrical component of the disclosure integrates both a common mode choke and transformer, thereby providing an efficient and compact solution for data transmission.

In closing, according to one or more embodiments herein, an illustrative electronic device herein (e.g., an integrated transformer and common mode choke with twisted winding to increase bandwidth) may comprise: a generally toroidal magnetic core having a first extension portion coupled to a first location of the generally toroidal magnetic core and a second extension portion coupled to a second location of the generally toroidal magnetic core generally opposite the first location; a common mode choke comprising a first wire and a second wire wound around the first extension portion and the second extension portion in a same winding direction, wherein subsequent to the common mode choke: the first wire winds around the generally toroidal magnetic core in a first direction, and the second wire around the generally toroidal magnetic core in a second direction to form a primary winding; and a transformer comprising the primary winding and a secondary winding, wherein the secondary winding of the transformer comprises a third wire and a fourth wire wound around the generally toroidal magnetic core in opposite directions.

In one embodiment, the first extension portion and the second extension portion extend toward a center region of the generally toroidal magnetic core and meet at a midpoint of the center region to form a center pathway connection for the generally toroidal magnetic core.

In one embodiment, the first extension portion and the second extension portion extend away from a center region of the generally toroidal magnetic core. In one embodiment, the first extension portion and the second extension portion extend co-planarly with respect to the generally toroidal magnetic core. In one embodiment, the first extension portion and the second extension portion extend in parallel in a direction away from a plane of the generally toroidal magnetic core, and the first extension portion and the second extension portion connect to one another to form a non-planar pathway connection.

In one embodiment, the first extension portion and the second extension portion are cylindrical in shape.

In one embodiment, the first extension portion and the second extension portion are quadrilateral in shape.

In one embodiment, the electronic device further comprises: a first port; and a second port, wherein the first wire and the second wire are coupled to the first port, and the third wire and the fourth wire are coupled to the second port. In one embodiment, the first wire and the second wire are configured as inputs to the first port, and the third wire and the fourth wire are configured as inputs to the second port. In one embodiment, the first port is configured to receive a common mode signal to operate the common mode choke.

In one embodiment, the first wire, the second wire, the third wire, and the fourth wire are twisted together when wrapped around the generally toroidal magnetic core. In one embodiment, the first wire, the second wire, the third wire, and the fourth wire are twisted together when wrapped around the generally toroidal magnetic core to cause the transformer to meet a bandwidth criterion. In one embodiment, the bandwidth criterion corresponds to a 10-GHz bandwidth requirement.

In one embodiment, the first direction is a clockwise direction with respect to the generally toroidal magnetic core and the second direction is an anti-clockwise direction with respect to the generally toroidal magnetic core.

In one embodiment, the third wire and the fourth wire are merged at a first center tap to form the secondary winding, and the first wire and the second wire are merged at a second center tap to form the primary winding.

In one embodiment, the first extension portion and the second extension portion are thinner than the generally toroidal magnetic core.

In one embodiment, the first extension portion and the second extension portion are thicker than the generally toroidal magnetic core.

In one embodiment, the generally toroidal magnetic core, the common mode choke, and the transformer are deployed in a computer networking device.

According to one or more embodiments herein, an illustrative method herein may comprise: receiving, via a first port of an electronic device, a communication message; and communicating, via a second port of the electronic device, the communication message, wherein the electronic device comprises: a generally toroidal magnetic core having a first extension portion coupled to a first location of the generally toroidal magnetic core and a second extension portion coupled to a second location of the generally toroidal magnetic core generally opposite the first location; a common mode choke comprising a first wire and a second wire wound around the first extension portion and the second extension portion in a same winding direction, wherein subsequent to the common mode choke: the first wire winds around the generally toroidal magnetic core in a first direction, and the second wire winds around the generally toroidal magnetic core in a second direction to form a primary winding; and a transformer comprising the primary winding and a secondary winding, wherein the secondary winding of the transformer comprises a third wire and a fourth wire wound around the generally toroidal magnetic core in opposite directions.

According to one or more embodiments herein, an illustrative system herein may comprise: a printed circuit board deployed in a computer networking device; and an electronic device coupled to the printed circuit board, wherein the electronic device comprises: a generally toroidal magnetic core having a first extension portion coupled to a first location of the generally toroidal magnetic core and a second extension portion coupled to a second location of the generally toroidal magnetic core generally opposite the first location; a common mode choke comprising a first wire and a second wire wound around the first extension portion and the second extension portion in a same winding direction, wherein subsequent to the common mode choke: the first wire winds around the generally toroidal magnetic core in a first direction, and the second wire winds around the generally toroidal magnetic core in a second direction to form a primary winding; and a transformer comprising the primary winding and a secondary winding, wherein the secondary winding of the transformer comprises a third wire and a fourth wire wound around the generally toroidal magnetic core in opposite directions.

While there have been shown and described illustrative embodiments that provide an integrated component that operates as a transformer and common-mode choke, it is to be understood that various other adaptations and modifications may be made within the spirit and scope of the embodiments herein. For example, although particular connectors, such as RJ45 connectors may be employed in connection with embodiments of the present disclosure, it should be readily appreciated that the integrated components are suitable for any number of other electronic devices and/or applications, such as power converters (e.g., DC-DC converters), power supplies, PoE devices, or any other device that utilizes transformer-choke magnetics. Furthermore, although the specific configurations of the integrated components are shown in particular sizes, shapes, windings, number of cores, and the like, such specific configurations are for purposes of illustration, not limitation. The embodiments in their broader sense are not as limited, and may, in fact, be adapted for various other configurations. Additionally, the techniques herein may also be applied to single pair ethernet, and the embodiments shown and described above need not be limiting to the scope of the present disclosure.

The foregoing description has been directed to specific embodiments. It will be apparent, however, that other variations and modifications may be made to the described embodiments, with the attainment of some or all of their advantages. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. An electronic device, comprising:
a generally toroidal magnetic core having a first extension portion coupled to a first location of the generally toroidal magnetic core and a second extension portion coupled to a second location of the generally toroidal magnetic core generally opposite the first location;
a common mode choke comprising a first wire and a second wire wound around the first extension portion and the second extension portion in a same winding direction, wherein subsequent to the common mode choke:
the first wire winds around the generally toroidal magnetic core in a first direction, and the second wire around the generally toroidal magnetic core in a second direction to form a primary winding; and
a transformer comprising the primary winding and a secondary winding, wherein the secondary winding of the transformer comprises a third wire and a fourth wire wound around the generally toroidal magnetic core in opposite directions.

2. The electronic device of claim 1, wherein the first extension portion and the second extension portion extend toward a center region of the generally toroidal magnetic core and meet at a midpoint of the center region to form a center pathway connection for the generally toroidal magnetic core.

3. The electronic device of claim 1, wherein the first extension portion and the second extension portion extend away from a center region of the generally toroidal magnetic core.

4. The electronic device of claim 3, wherein the first extension portion and the second extension portion extend co-planarly with respect to the generally toroidal magnetic core.

5. The electronic device of claim 3, wherein:
the first extension portion and the second extension portion extend in parallel in a direction away from a plane of the generally toroidal magnetic core, and
the first extension portion and the second extension portion connect to one another to form a non-planar pathway connection.

6. The electronic device of claim 1, wherein the first extension portion and the second extension portion are cylindrical in shape.

7. The electronic device of claim 1, wherein the first extension portion and the second extension portion are quadrilateral in shape.

8. The electronic device of claim 1, further comprising:
a first port; and
a second port,
wherein the first wire and the second wire are coupled to the first port, and the third wire and the fourth wire are coupled to the second port.

9. The electronic device of claim 8, wherein:
the first wire and the second wire are configured as inputs to the first port, and
the third wire and the fourth wire are configured as inputs to the second port.

10. The electronic device of claim 8, wherein the first port is configured to receive a common mode signal to operate the common mode choke.

11. The electronic device of claim 1, wherein the first wire, the second wire, the third wire, and the fourth wire are twisted together when wrapped around the generally toroidal magnetic core.

12. The electronic device of claim 11, wherein the first wire, the second wire, the third wire, and the fourth wire are twisted together when wrapped around the generally toroidal magnetic core to cause the transformer to meet a bandwidth criterion.

13. The electronic device of claim 12, wherein the bandwidth criterion corresponds to a 10-GHz bandwidth requirement.

14. The electronic device of claim 1, wherein the first direction is a clockwise direction with respect to the generally toroidal magnetic core and the second direction is an anti-clockwise direction with respect to the generally toroidal magnetic core.

15. The electronic device of claim 1, wherein:
the third wire and the fourth wire are merged at a first center tap to form the secondary winding, and
the first wire and the second wire are merged at a second center tap to form the primary winding.

16. The electronic device of claim 1, wherein the first extension portion and the second extension portion are thinner than the generally toroidal magnetic core.

17. The electronic device of claim 1, wherein the first extension portion and the second extension portion are thicker than the generally toroidal magnetic core.

18. The electronic device of claim 1, wherein the generally toroidal magnetic core, the common mode choke, and the transformer are deployed in a computer networking device.

19. A method, comprising:
receiving, via a first port of an electronic device, a communication message; and
communicating, via a second port of the electronic device, the communication message, wherein the electronic device comprises:
a generally toroidal magnetic core having a first extension portion coupled to a first location of the generally toroidal magnetic core and a second extension portion coupled to a second location of the generally toroidal magnetic core generally opposite the first location;
a common mode choke comprising a first wire and a second wire wound around the first extension portion and the second extension portion in a same winding direction, wherein subsequent to the common mode choke:
the first wire winds around the generally toroidal magnetic core in a first direction, and the second wire winds around the generally toroidal magnetic core in a second direction to form a primary winding; and
a transformer comprising the primary winding and a secondary winding, wherein the secondary winding of the transformer comprises a third wire and a fourth wire wound around the generally toroidal magnetic core in opposite directions.

20. A system, comprising:
a printed circuit board deployed in a computer networking device; and
an electronic device coupled to the printed circuit board, wherein the electronic device comprises:
a generally toroidal magnetic core having a first extension portion coupled to a first location of the generally toroidal magnetic core and a second extension portion coupled to a second location of the generally toroidal magnetic core generally opposite the first location;
a common mode choke comprising a first wire and a second wire wound around the first extension portion and the second extension portion in a same winding direction, wherein subsequent to the common mode choke:
the first wire winds around the generally toroidal magnetic core in a first direction, and the second wire winds around the generally toroidal magnetic core in a second direction to form a primary winding; and
a transformer comprising the primary winding and a secondary winding, wherein the secondary winding of the transformer comprises a third wire and a fourth wire wound around the generally toroidal magnetic core in opposite directions.
